(19) United States
(12) Patent Application Publication
(10) Pub. No.: US 2008/0256485 A1
(43) Pub. Date: Oct. 16, 2008

(54) User Interface for Controlling Video Programs on Mobile Computing Devices

(76) Inventor: Jason Gary Krikorian, San Mateo, CA (US)

Correspondence Address: INGRASSIA FISHER & LORENZ, P.C. (ES), 7010 E. COCHISE ROAD, SCOTTSDALE, AZ, 85253, US

(21) Appl. No.: 11/734,277

(22) Filed: Apr. 12, 2007

(51) Int. Cl. G06F 3/00

(52) U.S. Cl. 715/810; 715/719

(57) ABSTRACT

A user interface allows users of computing devices to control video content displayed on the computing devices. A device displays an overlay of a menu on top of an active video stream, the menu including a set of commands for controlling the video content. The commands may be associated with a key or other input item of the computing device. A user can select a command on the menu by pressing the associated key, touching a designated area of the screen, or otherwise selecting the command, and the selected command is then used to affect the displayed video content.

### BACKGROUND

1. Field of the Invention

This invention relates generally to media applications, and in particular to user interfaces for viewing and controlling video programs received on a portable device or a device otherwise having limited screen space.

2. Background of the Invention

Television and other video content are increasingly finding a home on mobile computing devices, such as mobile phones, personal digital assistants (PDAs), and personal video players (PVPs). For example, television programming is no longer found solely on the television. Through computer networks, as well as other delivery mechanisms, television and other media content are increasingly becoming available on these mobile computing devices.

Mobile computing devices generally have smaller screens than traditional televisions and computer monitors due to these devices' mobility. This restriction in size also tends to limit the display resolution of the screens. A common screen size for a portable device that can display video streams is 2.5-inch by 2.5-inch. When a user watches video on such a small screen, it is hard to design an effective interface for the user to control the program playing the video or executing other commands on the device.

One conventional approach to provide video control is by displaying visual controls (e.g., a control menu) on the screen. However, the menu structure may unduly conceal the video screen which may be showing active video. The menu structures are also unfriendly to users, as they force the user to search for the control commands in the menu hierarchy.

Another conventional approach to solve this problem is to dedicate control functions to certain hard buttons or keys (i.e., similar to a “speed dial” mechanism, where a command “Channel Up” can be achieved by pressing the number “3” on a keypad). However, these designations force the user to remember the designation (or at least look up the designation, such as via the same menu system) and are thus less user friendly than desired.

Accordingly, there is a need for a better user interface to allow users of mobile computing devices to control video programs viewed on those devices.

### SUMMARY

Embodiments of the invention provide a user interface for users of computing devices to control video content displayed on the computing devices. In one embodiment, while displaying a video stream, a computing device displays an overlay of a command menu on top of the active video stream. The device may display this menu overlay in response to an active request therefor by the user or in response to some other event. The command menu includes a set of commands for controlling the video stream, and the commands may each be associated with a key or other input item of the mobile computing device. A user can then select a command on the menu by pressing the associated key. The device may then use the selected command to affect the video stream according to any suitable method.

In one embodiment, the commands on the menu are displayed on the screen of the device in an orientation that corresponds to the positions of the keys associated with the commands. In another embodiment, the commands are displayed next to representations of their associated keys.

### BRIEF DESCRIPTION OF THE DRAWINGS

FIG. 1 is a block diagram illustrating an architecture of a device for displaying a video stream, according to one embodiment of the invention.

FIG. 2 is a flowchart of a method for controlling a video program, in accordance with an embodiment of the invention.

FIGS. 3(a) and 3(b) illustrate examples of user interfaces for receiving a control command to control a video program, in accordance with embodiments of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### Overview

Embodiments of the invention provide users of mobile computing device a mechanism to control video applications (or programs) on the mobile computing device. A menu of commands is displayed as an overlay on the live video content being played on the screen, thereby reducing the impact on the user experience in viewing the video content and also making the control of the video content more convenient and intuitive for the user.

In one embodiment, the commands are associated with keys on the mobile computing device. Therefore, a user can select a command by pressing (or triggering) the key associated with the command. The commands can be displayed in positions corresponding to the positions of their associated keys. In this way, a user can identify the key associated with the command of interest by the display position of the command. Alternatively, the commands can be displayed together with representations of the associated keys.

### System Architecture

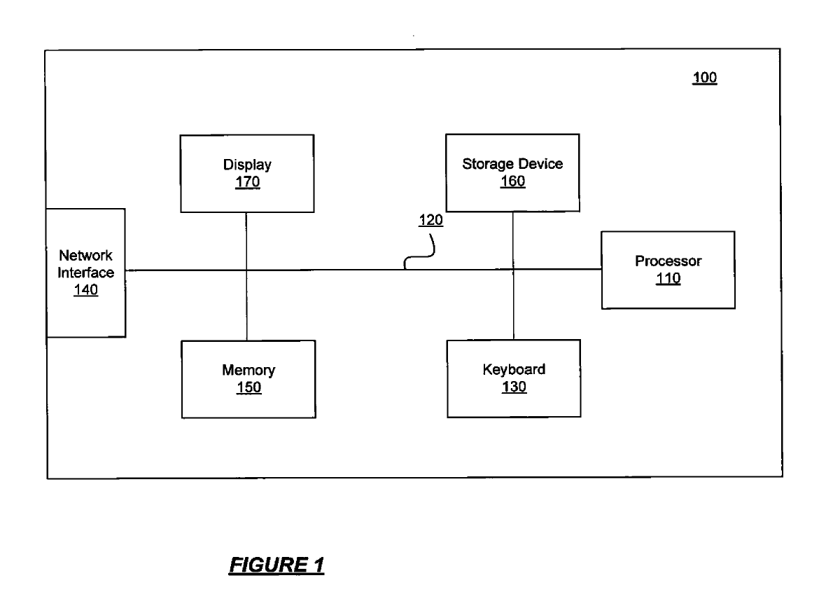

Referring to FIG. 1, there is shown a block diagram illustrating the architecture of a mobile computing system 100 (system 100) in accordance with one embodiment of the present invention. As shown, the system 100 includes a processor 110 coupled to a bus 120. Also coupled to the bus 120 are a keyboard 130, a network interface 140, a memory 150, a storage device 160, and a display 170.

The processor 110 may be any general-purpose processor such as an INTEL x86, SUN MICROSYSTEMS SPARC, or POWERPC compatible-CPU. The storage device 160 is, in one embodiment, a hard disk drive but can also be any other device capable of storing data, such as a solid-state memory device. The memory 150 may be, for example, firmware, read-only memory (ROM), non-volatile random access memory (NVRAM), and/or RAM, and holds instructions and data used by the processor 110. The network interface 140 couples the system 100 to a local network (e.g., a home network) or a remote network (e.g., the Internet). The bus 120 is an electrical conductor that serves as an electrical pathway along which signals are sent from components connected to the bus. The display 170 is an output screen on which visual information is displayed. The display 170 can be a touch-sensitive screen which users can interact with the system 100 by touching the display 170. The keyboard can be a 3×4 keypad standard for touch-tone telephones, a QWERTY keyboard, or any other types of keyboard. In many instances the system 100 lacks one or more of the elements shown in FIG. 1, such as a storage device 160, and/or a network interface 140.

As is known in the art, the computer 200 is adapted to execute computer program modules (or programs). As used herein, the term “module” refers to computer program logic and/or data for providing the specified functionality. A module can be implemented in hardware, firmware, and/or software. In one embodiment, the modules are stored on the storage device 160, loaded into the memory 150, and executed by the processor 110.

The system 100 can also optionally include an input interface (not shown) to connect to external devices such as a place-shifting system, a time-shifting system, a personal video recorder (DVR), a personal broadcaster, and a video camera. Detailed description and embodiments of a place-shifting system and a personal broadcaster can be found in U.S. patent application Ser. No. 11/147,664, filed on Jun. 7, 2005, which is hereby incorporated by reference in its entirety.

The input interface can also connect to analog cable or antenna and receive radio frequency signal (RF signal) from them. Because an RF signal includes a number of video signals modulated therein, the input interface can be coupled to provide the RF input to a tuner (not shown). The tuner filters the RF signal for a selected channel, demodulates the channel, and converts the signal into separate analog video and audio for further processing by the processor 110. The connection between the external devices and the system 100 can be either wired connection (e.g., cable) or wireless connection (e.g., Bluetooth).

### Overview of Methodology

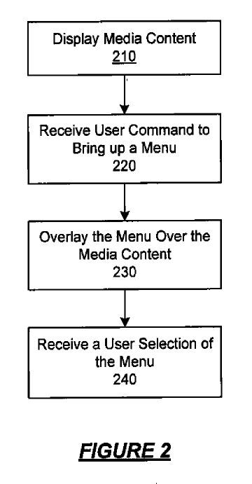

FIG. 2 is a flowchart of an exemplary operation of the mobile computing system 100 (system 100) for controlling a video software program in accordance with one embodiment of the invention. In this example, the system 100 is a smart phone with a screen where users of the smart phone can view graphical content (e.g., pictures) and video content (e.g., video clips). The process illustrated in FIG. 2 may be implemented in software, hardware, or a combination of hardware and software.

The process illustrated in FIG. 2 starts with the system 100 displaying 210 video program on the display 170. As used herein, video program may include any type of video, graphics, still images, and a combination thereof. In one embodiment, the display 170 is a screen with limited size (e.g., 35×44 mm) and low display resolution (e.g., 176×220 pixels). The display 170 can also support other display resolution such as 320×240 pixels and 640×480 pixels. The video program can be displayed by a video program executed in the system 100. One example of such application is a media player client as described in U.S. patent application Ser. No. 11/147,664, filed on Jun. 7, 2005, the content of which are hereby incorporated by reference.

The video program being displayed can be from multiple sources. As described above with reference to FIG. 1, the system 100 can receive video program from analog cable or antenna. The system 100 can also receive video program and/or video stream from the connected external devices (e.g., place-shifting systems and time-shifting systems) or online sources such as media content sharing community websites. Alternatively the video program can be from the storage device 160.

The system 100 receives 220 a user command to bring up a menu. The user can input the command by pressing a key in the keyboard 130, or touch a screen if the display 170 includes a touch-sensitive screen. The key can be a soft key or a designated key. A soft key is a key located below the display 170 and linked to the bottom section of the display 170. It performs whatever function is listed on the display 170. A designated key can be any key on the keyboard 130 that is designated by the video program to bring up the menu. For example, the designated key can be the key “#”. In one embodiment, the user can toggle on and off the overlaid menu by pressing the same key.

The menu can be a control menu of the software displaying the video program. For example, the items in the menu may comprise commands such as pause, fast backward, fast forward, previous and next. Alternatively, the menu can include commands that is related to the system 100 (e.g., power off) or external devices (e.g., requesting the media source to transmit the next video program unit to the system 100). The commands can be discrete commands, or they can be macros (a series of commands strung together to execute an action). For example, a command might be labeled “CNN.” This command might act as a “bookmark” to bring the user to the Channel CNN. E.g., the keys “2,” “0,” “2” might be executed in succession if the channel number for CNN is 202. In some embodiments, commands in the menu can bring up submenus.

The system 100 overlays 230 the menu over the video program as the video program is displayed alive on the display 170. In one embodiment, the background of the commands on the menu is transparent, minimizing the video program being blocked by the overlaid menu. In another embodiment, the commands on the menu are displayed semi-transparently, rather than in solid color. Therefore, users can have the complete view of the video program with the menu overlaid on top.

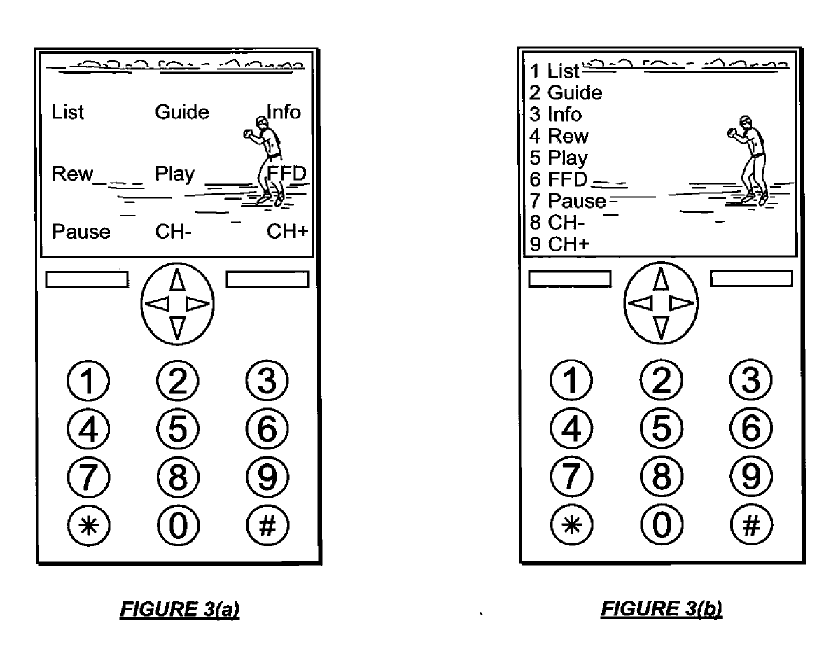

In one embodiment, commands (or menu items) in the menu are assigned to keys on the keyboard 130, and displayed in positions mapping to the key assignments. One example of this arrangement is illustrated in FIG. 3(a). In FIG. 3(a), the menu includes nine commands: List, Guide, Info, Rew, Play, FFD, Pause, Ch− and Ch+. The keypad includes twelve keys: Key “1,” Key “2,” Key “3,” Key “4,” Key “5,” Key “6,” Key “7,” Key “8,” Key “9,” Key “*,” Key “0” and Key “#.” Each of the nine commands is assigned to a key on the keypad. Command List is assigned to Key “1,” Guide to Key “2,” Info to Key “3,” Rew to Key “4,” Play to Key “5,” FFD to Key “6,” Pause to Key “7,” Ch− to Key “8,” and Ch+ to Key “9.” The commands are displayed on the screen in positions mapping the positions of the keys assigned on the keyboard 130, as illustrated in the following tables.

TABLE 1

| | | |
|---|---|---|
| List | Guide | Info |
| Rew | Play | FFD |
| Pause | Ch− | Ch+ |

TABLE 2

| | | |
|---|---|---|
| 1 | 2 | 3 |
| 4 | 5 | 6 |
| 7 | 8 | 9 |

Table 1 illustrates the commands as they are displayed on the screen. Table 2 illustrates the layout of the keyboard. As illustrated, the keys in Table 2 correspond to the commands in Table 1 according to their relative positions in the table. For example, the command List is mapped to Key “1,” which is to the left of Key “2” and above Key “4.” Therefore, the command List (or a symbol representing the command) would be displayed to the left of Guide, the command mapping Key “2,” and above Rew, the command mapping Key “4.”

In another embodiment, rather than displaying commands in positions mapping the positions of the assigned keys, the commands can be displayed next to representations of the associated keys. One example of this arrangement is illustrated in FIG. 3(b). In FIG. 3(b), same as in the example illustrated in FIG. 3(a), the menu includes nine commands: List, Guide, Info, Rew, Play, FFD, Pause, Ch− and Ch+, and the nine commands are assigned to Key “1,” Key “2,” Key “3,” Key “4,” Key “5,” Key “6,” Key “7,” Key “8” and Key “9” accordingly. The commands are displayed vertically on the screen overlaying the video program together with their associated keys. For example, the command List is displayed as 1 List, indicating that the key associated with List is Key “1.” One skilled in the art will recognize that this invention is not restricted to the traditional 3×4 keypad alignment. The assignment of the keys in the keyboard 130 to the commands in the menu can be configured manually by the user or automatically by the system 100.

Referring back to FIG. 2, the system 100 receives 240 a user selection of the overlaid menu. The user can make the selection by pressing the key associated with the command. If the commands are displayed in positions mapping the associated keys, the user can identify the associated key by locating the key in the corresponding position on the keyboard 130. If the commands are displayed together with representations of the associated keys, the user can identify the associated key by the displayed representation. Either way, the user can use the keyboard 130 to choose commands displayed on the screen without having to memorize the assignment (or association) of the commands to the keys in the keyboard 130. If the display 170 includes a touch-sensitive screen, the user can conduct the selection by touching the intended command overlaid above the video program.

After the system 100 receives 240 the user selection, it can identify the corresponding command and process accordingly. In one embodiment, the corresponding command can trigger a control command on a system separate from the system 100. For example, as set forth above, the system 100 can display video program and/or video stream received from external devices such as place-shifting systems and time-shifting systems. The command selected may correspond to a control command of the place-shifting system streaming the video program to the system 100, such as a switching channel command. The system 100 may transmit the corresponding control command to the place-shifting system. The place-shifting system may interpret the received control command and operate accordingly. Alternatively, the place-shifting system may issue another command for another system (e.g., a set top box). The corresponding control command and the issued command can be transmitted through supported transmission mechanisms, such as infrared transmission, radio frequency transmission, RS-232 transmission, and Internet Protocol transmission.

One skill in the art will recognize that the method described above can be used in a number of circumstances or applications. It can be used with simple file based playback (e.g., where user might want to skip to the next chapter in a video). It can be used in a streaming video service (e.g., where the user might want to quickly select the next video in the service, or perhaps pull up a server based menu of videos to select). It can also be used in the place-shifting scenario, where the user streams video program from another location (e.g., a set top box at home) and can control the source.

### SUMMARY

Embodiments of the invention provide users of mobile computing devices a mechanism to control video software program by overlaying a menu of commands on the video content being played on the screen. The commands are associated with keys on the device. The commands can be displayed in positions mapping the positions of the associated keys. Alternatively, the commands can be displayed together with an indication of the keys. Users can select a command by triggering the associated key on the device.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for controlling video content displayed on a device, the method comprising:
displaying a received video program on a display of the device;
receiving a user command to bring up a menu on the display of the device;
responsive to the user command, overlaying the menu over the video program on the display, the menu including a plurality of user-selectable items for controlling the displaying of the video program on the display of the device; and
receiving a user selection of an item from the menu.

2. The method of claim 1, wherein the device is a mobile device.

3. The method of claim 1, wherein the display of the device has a display resolution less than or equal to VGA.

4. The method of claim 1, wherein the display has a resolution with less than 307,200 pixels total.

5. The method of claim 1, wherein the dimensions of the display are each less than two inches.

6. The method of claim 1, wherein the video program comprises streaming video.

7. The method of claim 1, wherein the user command is received through a soft key of the device.

8. The method of claim 1, wherein the user command is received through a predefined key of the device.

9. The method of claim 8, wherein the predefine key is the # key.

10. The method of claim 1, further comprising:
receiving a user command to hide the menu; and
responsive to the user command to hide the menu, hiding the overlaid menu.

11. The method of claim 1, wherein each of at least some of the user-selectable items in the menu is selectable via a key on a keypad of the device, and wherein an orientation of the items in the menu corresponds to an orientation of the associated keys on the keypad, thereby communicating the association of the items with the keys.

12. The method of claim 1, wherein each of at least some of the user-selectable items in the menu is selectable via a key on a keypad of the device, and wherein the menu displays the items along with representations of the keys associated therewith.

13. The method of claim 12, wherein the menu is displayed as a list of items along with the representations of the keys associated with the items.

14. The method of claim 1, wherein receiving the user selection comprises receiving the user selection with a touch-sensitive screen of the display.

15. The method of claim 1, wherein receiving the user selection comprises receiving the user selection via a key of the device, the key associated with an item in the menu.

16. The method of claim 1, wherein at least one of the items in the menu is a macro.

17. The method of claim 1, further comprising:
controlling the displaying of the video program on the display of the device based on the user selection.

18. The method of claim 17, wherein controlling the displaying of the video program comprises:
transmitting a control command to a system, the video program being received from the system, the control command being associated with the user selection.

19. The method of claim 18, wherein transmitting the control command further comprises transmitting the control command to the system using a transmission mechanism selected from a group consisting of: infrared transmission, radio frequency transmission, RS-232 transmission, and Internet Protocol transmission.

20. A computer program product for controlling video content played on a device, the computer program product comprising a computer-readable medium containing computer program code for performing the method comprising:
displaying a received video program on a display of the device;
receiving a user command to bring up a menu on the display of the device;
responsive to the user command, overlaying the menu over the video program on the display, the menu including a plurality of user-selectable items for controlling the displaying of the video program on the display of the device; and
receiving a user selection of an item from the menu.

21. The computer program product of claim 20, wherein the device is a mobile device.

22. The computer program product of claim 20, wherein the display of the device has a display resolution less than or equal to VGA.

23. The computer program product of claim 20, wherein the display has a resolution with less than 307,200 pixels total.

24. The computer program product of claim 20, wherein the dimensions of the display are each less than two inches.

25. The computer program product of claim 20, wherein the video program comprises streaming video.

26. The computer program product of claim 20, wherein the user command is received through a soft key of the device.

27. The computer program product of claim 20, wherein the user command is received through a predefined key of the device.

28. The computer program product of claim 27, wherein the predefine key is the # key.

29. The computer program product of claim 20, wherein the method further comprising:
receiving a user command to hide the menu; and
responsive to the user command to hide the menu, hiding the overlaid menu.

30. The computer program product of claim 20, wherein each of at least some of the user-selectable items in the menu is selectable via a key on a keypad of the device, and wherein an orientation of the items in the menu corresponds to an orientation of the associated keys on the keypad, thereby communicating the association of the items with the keys.

31. The computer program product of claim 20, wherein each of at least some of the user-selectable items in the menu is selectable via a key on a keypad of the device, and wherein the menu displays the items along with representations of the keys associated therewith.

32. The computer program product of claim 31, wherein the menu is displayed as a list of items along with the representations of the keys associated with the items.

33. The computer program product of claim 20, wherein receiving the user selection comprises receiving the user selection with a touch-sensitive screen of the display.

34. The computer program product of claim 20, wherein receiving the user selection comprises receiving the user selection via a key of the device, the key associated with an item in the menu.

35. The computer program product of claim 20, wherein at least one of the items in the menu is a macro.

36. The computer program product of claim 20, wherein the method further comprising:
controlling the displaying of the video program on the display of the device based on the user selection.

37. The computer program product of claim 36, wherein controlling the displaying of the video program comprises:
transmitting a control command to a system, the video program being received from the system, the control command being associated with the user selection.

38. The computer program product of claim 37, wherein transmitting the control command further comprises transmitting the control command to the system using a transmission mechanism selected from a group consisting of: infrared transmission, radio frequency transmission, RS-232 transmission, and Internet Protocol transmission.

39. A computer program product for controlling video content played on a device, the computer program product comprising a computer-readable medium containing computer program code for providing a user interface, the user interface comprising:
a display area for displaying a video program and a menu, wherein the menu can be overlaid in the display area over the video program; and
an executable process, the executive process receiving a user selection of the menu.

40. A method for controlling video content displayed on a device, the method comprising:
displaying a received video program on a display of the device;
receiving a user command to bring up a menu on the display of the device;
responsive to the user command, overlaying the menu over the video program on the display, the menu including a plurality of user-selectable items for controlling the displaying of the video program on the display of the device, wherein each of at least some of the user-selectable items is selectable via a key on a keypad of the device, and wherein an orientation of the items in the menu corresponds to an orientation of the associated keys on the keypad, thereby communicating the association of the items with the keys; and
receiving a user selection of an item from the menu via the key associated with the item.
